(19) United States
(12) Patent Application Publication
(10) Pub. No.: US 2024/0411127 A1
(43) Pub. Date: Dec. 12, 2024

(54) HEAD MOUNT DEVICE AND LIGHT GUIDANCE DEVICE

(71) Applicant: SONY GROUP CORPORATION, TOKYO (JP)

(72) Inventors: YUICHI HASEGAWA, TOKYO (JP); JUN NISHIKAWA, TOKYO (JP)

(21) Appl. No.: 18/699,365

(22) PCT Filed: Sep. 12, 2022
(86) PCT No.: PCT/JP2022/033995

§ 371 Date: Apr. 8, 2024

(30) Foreign Application Priority Data
Oct. 15, 2021 (JP) 2021-169617

(51) Int. Cl. G02B 27/00; G06F 1/16

(52) U.S. Cl. CPC G02B 27/0081; G06F 1/163

(57) ABSTRACT

A head mount device (100) includes a housing (110, 120) and a light guidance unit (130). The housing (110, 120) is configured to fix a portable display device (200) thereto. The light guidance unit (130) is configured to change an angle of view of a sensor (212) mounted on the portable display device (200) so as to allow the sensor (212) to sense at least a lower region below a line-of-sight direction of a user in a mounting state in which the portable display device (200) is fixed to the housing (110, 120), and the housing (110, 120) is mounted on the user.

### FIELD

The present disclosure relates to a head mount device, a portable display device, and a light guidance device.

### BACKGROUND

Known is a technique of displaying images rendered using augment reality (AR) and virtual reality (VR) on, for example, a head mounted display (HMD) worn by a user.

The HMD receives an operation from the user by detecting pressing of a switch by the user or detecting a gesture of the user using a mounted camera, and presents an image corresponding to the operation to the user.

### CITATION LIST

### Patent Literature

Patent Literature 1: JP 2016-130985 A

### SUMMARY

### Technical Problem

In recent years, various types of HMDs, such as one that includes a display device and displays an image rendered by a rendering device, which is an external device, and one that includes both a display device and a rendering device and can perform both rendering and display of an image, have been developed.

In addition to the above-described HMD, for example, a type of HMD using a portable terminal such as a smartphone as a display device is known. In this case, a user wears the HMD in which the smartphone is fixed to a housing, and views an image displayed on the screen of the smartphone.

As described above, in the case of an HMD using a smartphone, there is demand for detecting a gesture of the user using a sensor mounted on the smartphone.

For example, a recent smartphone is equipped with a distance measurement sensor that measures a distance to a subject using infrared light (IR). By detecting motion of the hand of the user using the distance measurement sensor mounted on the smartphone, the HMD can more easily receive an operation from the user without mounting a sensor, a switch, or the like on the housing.

Here, since the distance measurement sensor mounted on the smartphone is used for autofocus of a camera or the like, the angle of view of the camera is narrower than the viewing angle of the HMD. Therefore, when an attempt is made to detect the hand of the user wearing the HMD by using the distance measurement sensor mounted on the smartphone, for example, the user needs to move the hand to the angle of view (distance measurement range) of the distance measurement sensor, which may become a burden on the user.

Therefore, the present disclosure provides a mechanism capable of further reducing a burden on a user in a case where a distance measurement sensor included in a portable display device is used in an HMD using the portable display device such as a smartphone.

It is noted that the above-described problem or object is merely one of a plurality of problems or objects that can be solved or achieved by a plurality of embodiments disclosed in the present specification.

### Solution to Problem

A head mount device of the present disclosure includes a housing and a light guidance unit. The housing is configured to fix a portable display device thereto. The light guidance unit is configured to change an angle of view of a sensor mounted on the portable display device so as to allow the sensor to sense at least a lower region below a line-of-sight direction of a user in a mounting state in which the portable display device is fixed to the housing, and the housing is mounted on the user.

### BRIEF DESCRIPTION OF DRAWINGS

FIG. 1 is a schematic diagram illustrating a schematic configuration example of an HMD according to a first embodiment of the present disclosure.

FIG. 2 is a diagram illustrating an example of detecting the hand of a user by the HMD according to the first embodiment of the present disclosure.

FIG. 3 is a diagram illustrating an angle of view of an image sensor according to the first embodiment of the present disclosure.

FIG. 4 is a diagram illustrating the angle of view of the image sensor according to the first embodiment of the present disclosure.

FIG. 5 is a diagram illustrating an example of the HMD according to the first embodiment of the present disclosure.

FIG. 6 is a diagram illustrating another example of a light guidance unit according to the first embodiment of the present disclosure.

FIG. 7 is a schematic diagram of a lid part according to the first embodiment of the present disclosure, as viewed from the front.

FIG. 8 is a schematic diagram of the HMD according to the first embodiment of the present disclosure, as viewed from the side.

FIG. 9 is a schematic diagram illustrating a configuration example of the light guidance unit according to the first embodiment of the present disclosure.

FIG. 10 is a block diagram illustrating a configuration example of a portable display device according to the first embodiment of the present disclosure.

FIG. 11 is a schematic diagram illustrating a configuration example of an HMD according to a first modification of the first embodiment of the present disclosure.

FIG. 12 is a schematic diagram illustrating a configuration example of an HMD according to a second modification of the first embodiment of the present disclosure.

FIG. 13 is a schematic diagram illustrating a configuration example of an HMD according to a third modification of the first embodiment of the present disclosure.

FIG. 14 is a diagram illustrating light guided by first and second light guidance units according to a second embodiment of the present disclosure.

FIG. 15 is a block diagram illustrating a configuration example of a portable display device according to a third embodiment of the present disclosure.

FIG. 16 is a diagram illustrating transmittance determined by a transmittance determination unit according to the third embodiment of the present disclosure.

FIG. 17 is a diagram illustrating the transmittance determined by the transmittance determination unit according to the third embodiment of the present disclosure.

FIG. 18 is a diagram illustrating the transmittance determined by the transmittance determination unit according to the third embodiment of the present disclosure.

FIG. 19 is a block diagram illustrating a configuration example of a portable display device according to a fourth embodiment of the present disclosure.

FIG. 20 is a diagram illustrating an example of a method of detecting a mounting deviation by a deviation detection unit according to the fourth embodiment of the present disclosure.

FIG. 21 is a diagram illustrating another example of the method of detecting the mounting deviation by the deviation detection unit according to the fourth embodiment of the present disclosure.

### DESCRIPTION OF EMBODIMENTS

Hereinafter, embodiments of the present disclosure will be described in detail with reference to the accompanying drawings. It is noted that, in the present specification and the drawings, components having substantially the same functional configuration are denoted by the same reference numerals, and a redundant description thereof is omitted.

Furthermore, in the present specification and the drawings, similar components of the embodiments may be distinguished by adding different alphabets or numbers after the same reference numerals. However, in a case where it is not necessary to particularly distinguish each of similar components, only the same reference numeral is assigned thereto.

Furthermore, in the present specification and the drawings, a description may be given by indicating a specific value, but the value is merely an example, and another value may be applied.

One or more embodiments (including examples and modifications) described below can each be implemented independently. On the other hand, at least some of the plurality of embodiments described below may be appropriately combined with at least some of other embodiments to be implemented. The plurality of embodiments may include novel features different from each other. Therefore, the plurality of embodiments can contribute to solving different objects or problems, and can exhibit different effects.

### 1. First Embodiment

### 1.1. Introduction

As described above, in recent years, various types of HMDs have been developed. For example, there is known a type (hereinafter, also referred to as a mothership-connection-type) of HMD in which a display device is mounted and an image rendered by a rendering device, which is an external device, is displayed on the display device. This mothership-connection-type HMD has a problem in that a cable is required to be connected to the rendering device and, as such, the cable may restrict movement of the user and hinder user's experience.

In order to solve this problem, research and development has been conducted on a technology of connecting the mothership-connection-type HMD to the rendering device by wireless communication. The HMD can omit the cable by being connected to the rendering device by wireless communication, but there are problems such as communication delay and communication quality.

It is noted that the rendering device is disposed near a user wearing the HMD. Alternatively, the rendering device may be provided on a cloud. In this case, the HMD displays, for example, an image rendered in a data center on the cloud on a display. In a case where the rendering device is provided on the cloud, display delay of the image becomes a large problem. However, when the display delay can be suppressed by prediction and low delay technology, the HMD can provide a higher quality video to the user.

As another type of HMD, for example, there is known a type (hereinafter, also referred to as a standalone-type) of HMD in which both a display device and a rendering device are mounted and image rendering and display are realized by one HMD. The standalone-type HMD has no hindrance to the movement of the user, such as a cable, but has a problem in that rendering capability and image quality are lower than those of the mothership-connection-type HMD.

In addition to the above-described mothership-connection-type and standalone-type, there is known a type (hereinafter, also referred to as a simplified type) of HMD in which a portable display device such as a smartphone is mounted on a head mount device. In the simplified-type HMD, a user can more easily experience VR by using a smartphone as a display device and a rendering device.

The first embodiment of the present disclosure provides a mechanism capable of further reducing a burden on a user in the simplified-type HMD.

Here, a conventional HMD receives an operation from a user by a switch or the like provided in the HMD. Furthermore, the conventional HMD receives an operation from a user or controls an avatar serving as a virtual self of the user by recognizing the hand of the user.

For example, the HMD displays a virtual object on the virtual space, and detects a motion in which the user touches the virtual object. As a result, the HMD receives an operation of selecting the virtual object from the user. As described above, the HMD can provide the user with an intuitive UI by receiving the operation of the user according to the motion of the hand of the user.

Furthermore, the HMD controls the avatar using inverse kinematic technology in response to the position of the head or hand of the user. In this manner, the HMD can control the avatar in response to the motion of the user by detecting the position of the hand of the user.

Conventionally, the HMD uses a controller to detect the hand of the user. The controller tracks the six degree of freedom (6DoF) posture of the hand of the user separately from the HMD.

By using the controller, the HMD can detect the hand of the user with high accuracy. Meanwhile, in order to detect the hand of the user, it is necessary to prepare the controller separately from the HMD. In addition, the user needs to connect the controller to the HMD, the rendering device, or the like in a wireless or wired manner.

As a method of detecting the hand of the user, there is a method of detecting the hand using a camera other than a method of using the controller. The HMD uses a wide-angle camera mounted on the own device so as to track the posture of 6DoF of the own device. By using this wide-angle camera, the HMD can perform tracking of the hand of the user.

For example, the HMD detects the hand of the user from a captured image captured by the wide-angle camera. In order to detect a distance from the HMD to the hand of the user, parallax information of the camera is generally used. The camera for acquiring the parallax information may be a monocular camera or a multi-eye camera.

As described above, the conventional HMD needs to use the wide-angle camera or the like in order to detect the hand of the user. The above-described mothership-connection-type or standalone-type HMD can detect the hand relatively easily by using the wide-angle camera or the like already mounted.

On the other hand, in the simplified-type HMD, when a detection device for detecting the hand, such as a camera, is mounted on a housing to which a smartphone is attached, a power source is required on the housing side, or a cable for connecting the detection device to the smartphone is required. Therefore, in the simplified-type HMD, it is desired to provide a mechanism for detecting the hand of the user without mounting the detection device on the housing side.

Here, in recent years, a plurality of cameras and distance measurement sensors have started to be mounted on a portable information processing device such as a smartphone. For example, smartphones equipped with three types of cameras including standard, zoom, and wide angle, and a time of flight (ToF) sensor have appeared.

Therefore, in the first embodiment of the present disclosure, it is assumed that an HMD detects the hand of a user using a distance measurement sensor mounted on a portable display device such as a smartphone. As described above, when the HMD detects an object (for example, the hand of the user) using a sensor mounted on a portable display device, the HMD can detect the object without mounting an additional sensor.

### 1.2. Overview of HMD

### 1.2.1. Schematic Configuration Example of HMD

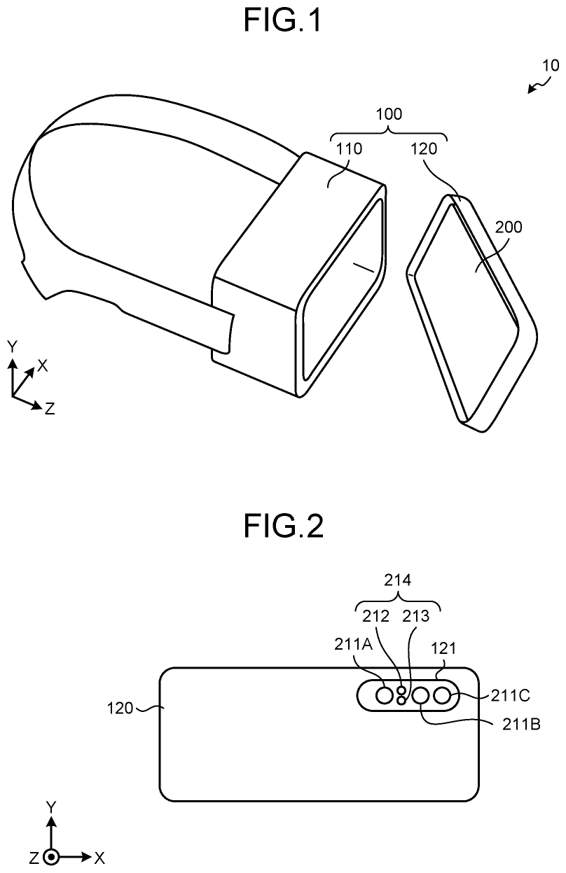

First, a schematic configuration example of an HMD 10 according to a first embodiment of the present disclosure will be described with reference to FIG. 1. FIG. 1 is a schematic diagram illustrating a schematic configuration example of the HMD 10 according to the first embodiment of the present disclosure.

It is noted that, in the drawings of the present disclosure, XYZ coordinates are shown for easy understanding. A Z-axis positive direction corresponds to a line-of-sight direction of a user in an upright state in which the user wears the HMD 10 and stands upright. A Z-axis direction is, for example, a direction perpendicular to a display surface of a portable display device 200 described later. A Y-axis positive direction corresponds to a direction opposite a gravity direction in the upright state of the user. A Y-axis direction corresponds to, for example, a lateral direction on the display surface of the portable display device 200. An X-axis positive direction is perpendicular to the Y-axis direction and the Z-axis direction and corresponds to a direction from the right eye to the left eye of the user. An X-axis direction corresponds to, for example, a longitudinal direction on the display surface of the portable display device 200.

It is noted that, in the following description, the front of the user when the user wears the HMD may be described as the front of the HMD, the upper side (head side) of a user U may be described as the upper side of the HMD, and the lower side (foot side) of the user U may be described as the lower side of the HMD.

As illustrated in FIG. 1, the HMD 10 includes a head mount device 100 and the portable display device 200.

The head mount device 100 includes a main body part 110 and a lid part 120. It is noted that the main body part 110 and the lid part 120 are also collectively referred to as a housing.

The main body part 110 includes, for example, a lens (not illustrated). The lid part 120 is configured to fix the portable display device 200 thereto. The lid part 120 is configured to be attachable to and detachable from the main body part 110. For example, the lid part 120 is mounted on the main body part 110 in a state of fixing the portable display device 200.

The head mount device 100 is a device including a lens (not illustrated) and having a lens barrel structure. The head mount device 100 is not equipped with a device that requires a power supply, such as a camera. Therefore, the head mount device 100 does not need an electric system such as a power supply and a cable.

The portable display device 200 is, for example, a small information processing device having a display surface. Examples of the portable display device 200 include a smartphone and a portable game machine. The portable display device 200 can function as a rendering device that performs image rendering. Furthermore, the portable display device 200 can function as a display device that displays a rendered image on the display surface.

For example, the portable display device 200 can display an image for the right eye on the right side obtained by dividing the display surface into two and display an image for the left eye on the left side. The user can view a three-dimensional image by viewing the image for the right eye through a lens for the right eye (not illustrated) and viewing the image for the left eye through a lens for the left eye (not illustrated). It is noted that the lens for the left eye and the lens for the right eye can be formed of, for example, a transparent material such as resin or glass.

Furthermore, the portable display device 200 includes sensors such as an imaging device (not illustrated) and a distance measurement sensor (not illustrated). The distance measurement sensor is used, for example, for autofocus at the time of photographing by the imaging device. The imaging device is used to capture an image around the portable display device 200.

It is noted that FIG. 1 illustrates a state in which a vertical smartphone is horizontally fixed to the lid part 120 as the portable display device 200, but the shape and fixing method of the portable display device 200 are not limited thereto. For example, the portable display device 200 may be an information processing terminal having a horizontal display surface. Alternatively, the portable display device 200 may be a device having a shape other than a rectangle, such as a square. In addition, the portable display device 200 may change its shape by being folded or slid.

As described above, the HMD 10 detects the hand of the user using the distance measurement sensor mounted on the portable display device 200. At this time, for example, as a method of directly using the distance measurement sensor for detecting the hand of the user, it is conceivable to use a method of providing an opening part 121 in the lid part 120, as illustrated in FIG. 2.

FIG. 2 is a diagram illustrating an example of detecting the hand of the user by the HMD 10 according to the first embodiment of the present disclosure. FIG. 2 illustrates the lid part 120 to which the portable display device 200 is fixed, as viewed from the Z-axis positive direction.

As illustrated in FIG. 2, the lid part 120 has the opening part 121. In the example of FIG. 2, the opening part 121 is configured to expose first to third imaging devices 211A to 211C, an image sensor 212, and a light source 213 of the portable display device 200.

The first to third imaging devices 211A to 211C are, for example, RGB imaging sensors capable of performing standard, zoom, and wide-angle imaging, respectively. The first to third imaging devices 211A to 211C can be rephrased as first to third cameras. It is noted that the types (standard, zoom, and wide-angle) of the first to third imaging devices 211A to 211C are not limited to the above-described examples. For example, the first imaging device 211A may be a zoom camera or a wide-angle camera instead of a standard camera.

Furthermore, at least two of the first to third imaging devices 211A to 211C may be the same type of camera. For example, both the first and second imaging devices 211A and 211B may be standard cameras.

In addition, the number of imaging devices 211 mounted on the portable display device 200 is not limited to three devices. The number of imaging devices 211 mounted on the portable display device 200 may be two or less, or may be four or more. Further, the portable display device 200 may not include the imaging device 211.

The image sensor 212 is, for example, a ToF sensor. The image sensor 212 is a distance measurement sensor that measures a distance by a ToF method of measuring a time from when the light source 213 emits light to when the light reflected by an object is received by a light receiving unit (not illustrated) of the image sensor 212.

It is noted that FIG. 2 illustrates a case in which the portable display device 200 includes one image sensor 212, but the present disclosure is not limited thereto. For example, the portable display device 200 may include two or more image sensors 212.

The light source 213 is configured to emit irradiation light toward an object. The light source 213 includes, for example, a light source unit (not illustrated) that emits infrared light. The light source unit includes, for example, a laser light source, a light emitting diode (LED), or the like. Furthermore, for example, a vertical cavity surface emitting laser (VCSEL), which is a surface light source, can be applied as the laser light source.

It is noted that FIG. 2 illustrates a case in which the portable display device 200 includes one light source 213, but the present disclosure is not limited thereto. For example, the portable display device 200 may include two or more light sources 213. Further, the portable display device 200 may not include the light source 213. In this case, the image sensor 212 can measure the distance using, for example, a light source (not illustrated) disposed separately from the HMD 10.

It is noted that the image sensor 212 and the light source 213 are also collectively referred to as a distance measurement device 214.

Furthermore, although not illustrated in FIG. 2, in addition to the imaging device 211 and the distance measurement device 214, for example, a hardware key (for example, a volume button or the like) mounted on the portable display device 200 may be exposed. In this manner, by exposing the hardware key, the user can operate the HMD 10 using the hardware key.

It is noted that, here, the exposure of the image sensor 212, the hardware key, and the like means that the image sensor 212, the hardware key, and the like are configured to operate in a state in which the portable display device 200 is fixed to the lid part 120. Therefore, the opening part 121 provided in the lid part 120 may be a hole formed in the lid part 120, or may be formed of a transparent material such as resin or glass.

### 1.2.2. Problem

As described above, the image sensor 212 mounted on the portable display device 200 is mainly used for autofocus or the like. Therefore, the image sensor 212 can perform detection in a distance of several meters, but an angle of view thereof (hereinafter, also referred to as an angle of view of the sensor) becomes narrower than a viewing angle (hereinafter, also referred to as an HMD viewing angle) of the HMD 10.

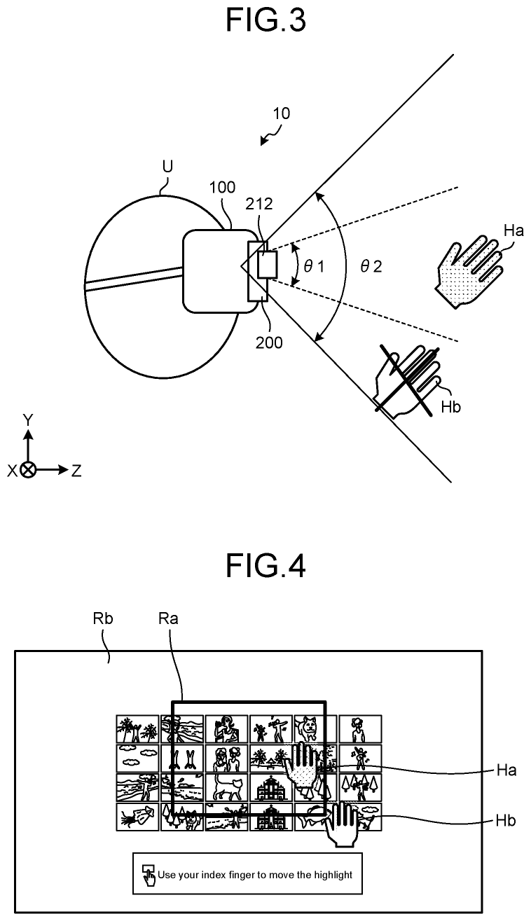

If the HMD 10 detects the hand of the user using the image sensor 212 as it is, there is a possibility that a burden is placed on the user U. This point will be described with reference to FIGS. 3 and 4.

FIGS. 3 and 4 are diagrams illustrating the angle of view of the image sensor 212 according to the first embodiment of the present disclosure. FIG. 3 illustrates a case in which the user U wears the HMD 10 and moves his/her hand. Furthermore, FIG. 4 illustrates an example of a rendered image presented to the user U by the HMD 10.

As illustrated in FIG. 3, the image sensor 212 has an angle of view of the sensor θ1, and detects a subject (for example, a hand Ha of the user U) existing in a region within the angle of view θ1. The HMD 10 has an HMD viewing angle θ2 (θ2>θ1) and displays a rendered image in a region within the viewing angle θ2.

As described above, the angle of view of the sensor θ1 is narrower than the HMD viewing angle θ2. Therefore, even if a hand Hb of the user U exists in the region within the HMD viewing angle θ2, in a case where the hand Hb does not exist in the region within the angle of view of the sensor θ1, the HMD 10 cannot detect the hand Hb.

Therefore, for example, when the user U tries to operate the HMD 10 with a gesture, the user U needs to move the hand to the region within the angle of view of the sensor θ1. Therefore, the burden on the user U increases. For example, the arms become tired.

Therefore, even if the hand Hb exists in the region within the HMD viewing angle θ2, in a case where the hand Hb does not exist in the region within the angle of view of the sensor θ1, the HMD 10 cannot recognize the hand Hb of the user U. That is, even if the user U moves the hand to a region visible on the virtual space, the HMD 10 may not be able to react to the hand of the user U.

For example, as illustrated in FIG. 4, it is assumed that the HMD 10 presents a menu screen for selecting a video to be reproduced to the user U. It is assumed that, for example, the user U selects the video to be reproduced by touching a preview image of a reproduction candidate video presented by the HMD 10 with the hand.

As described above, the angle of view of the sensor θ1 is narrower than the HMD viewing angle θ2. Therefore, the HMD 10 can detect, for example, the hand Ha of the user U existing in a region (for example, a region Ra in FIG. 4) within the angle of view of the sensor θ1, but cannot detect the hand Hb of the user U existing in a region (for example, a region Rb in FIG. 4) outside the angle of view of the sensor θ1.

Therefore, the user U cannot select the preview image unless the hand of the user U moves to the region Ra. Further, the user U cannot select the preview image outside the region Ra.

As described above, when the HMD 10 detects the hand of the user using the image sensor 212 as it is, there is a region that does not react even if the user U holds the hand and, as such, there is a problem in that the user U needs to move the hand to a reaction region, and a burden on the user U increases.

### 1.2.3. Outline of Proposed Technology

Therefore, the head mount device 100 of the HMD 10 according to the first embodiment of the present disclosure changes the angle of view of the sensor so as to allow the image sensor 212 to detect at least an object (for example, the hand of the user U) existing in a lower region below the line-of-sight direction of the user U.

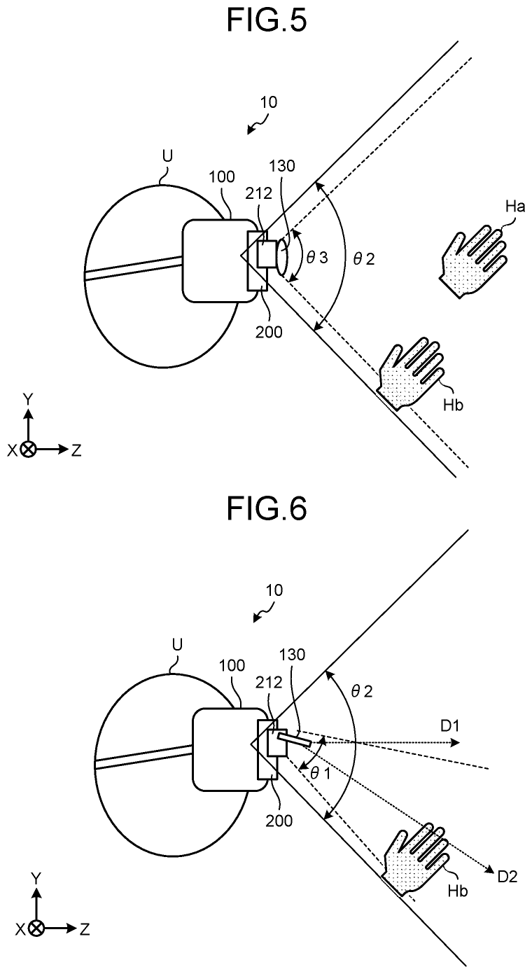

FIG. 5 is a diagram illustrating an example of the HMD 10 according to the first embodiment of the present disclosure. As illustrated in FIG. 5, the head mount device 100 includes a housing configured to fix the portable display device 200 thereto as described above, and a light guidance unit 130.

The light guidance unit 130 changes the angle of view of the image sensor 212 so as to allow the image sensor 212 to detect at least an object existing in a lower region below the line-of-sight direction of the user U (a Y-axis negative direction). In the example of FIG. 5, the light guidance unit 130 expands the angle of view of the image sensor 212 from θ1 (refer to FIG. 3) to θ3 (θ3>θ1). As a result, the HMD 10 can detect the object (for example, the hand Hb of the user U) existing in the lower region below the line-of-sight direction.

As described above, in a case where the light guidance unit 130 enlarges the angle of view of the sensor so as to change the angle of view of the sensor of the image sensor 212, the light guidance unit 130 can include, for example, a lens. It is noted that details of the light guidance unit 130 will be described later.

It is noted that, in FIG. 5, the angle of view of the sensor θ3 is narrower than the HMD viewing angle θ2, but the present disclosure is not limited thereto. For example, the light guidance unit 130 may expand the angle of view of the image sensor 212 so that the angle of view of the sensor θ3 is equal to or larger than the HMD viewing angle θ2 (θ3≥θ2).

A method of changing the angle of view of the sensor by the light guidance unit 130 is not limited to the method of enlarging the angle of view of the sensor. FIG. 6 is a diagram illustrating another example of the light guidance unit 130 according to the first embodiment of the present disclosure.

The light guidance unit 130 illustrated in FIG. 6 changes the direction of the image sensor 212, in other words, the direction of light incident on the image sensor 212 (hereinafter, also referred to as an incident direction) to a direction D2 lower than a line-of-sight direction D1 (the Y-axis negative direction).

As described above, the light guidance unit 130 causes the incident direction of the image sensor 212 to be directed downwards, so that the HMD 10 can detect the object (for example, the hand Hb of the user U) existing in the lower region below the line-of-sight direction.

As described above, in a case where the light guidance unit 130 changes the angle of view of the sensor of the image sensor 212 by changing the direction of the image sensor 212, the light guidance unit 130 can include, for example, a mirror or the like.

It is noted that, in FIG. 6, the angle of view of the sensor θ1 of the image sensor 212 is the same as that before the incident direction is changed, but the present disclosure is not limited thereto. For example, the light guidance unit 130 may expand the angle of view of the sensor of the image sensor 212 and change the incident direction.

Here, as described above, when the image sensor 212 is used for autofocus, a distance of about several meters is required as a detection range. However, the HMD 10 according to the first embodiment of the present disclosure uses the image sensor 212 to detect the hand of the user U. In this case, the distance required as the detection range may be about 1 m. Therefore, the HMD 10 can expand the angle of view of the sensor of the image sensor 212 or move the position of the optical axis of the angle of view of the sensor.

More specifically, when the angle of view of the sensor of the image sensor 212 is expanded or the position of the optical axis of the angle of view of the sensor is moved using the light guidance unit to be described later, light incident on the image sensor 212 is attenuated. However, as described above, in a case where the image sensor 212 is used for detecting the hand of the user U, the range of about 1 m is sufficient. Therefore, the HMD 10 can change the angle of view of the sensor using the light guidance unit.

In the first embodiment of the present disclosure, both the portable display device 200 and the light guidance unit 130 are fixed to the lid part 120 of the head mount device 100. That is, the position and posture of the HMD 10, the portable display device 200, and the light guidance unit 130 are fixed with respect to the face of the user U. Therefore, the HMD 10 can change the angle of view of the image sensor 212 by an optical approach using the light guidance unit 130.

### 1.3. Configuration Example of HMD

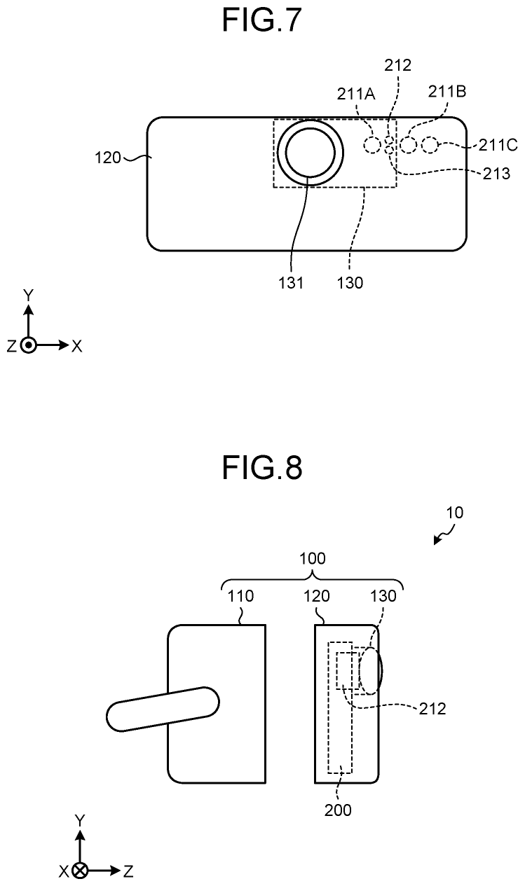

A configuration example of the HMD 10 according to the first embodiment of the present disclosure will be described with reference to FIGS. 7 and 8. FIG. 7 is a schematic diagram of the lid part 120 according to the first embodiment of the present disclosure, as viewed from the front. FIG. 7 is a diagram of the lid part 120 as viewed in the Z-axis positive direction. FIG. 8 is a schematic diagram of the HMD 10 according to the first embodiment of the present disclosure, as viewed from the side. FIG. 8 is a diagram illustrating the HMD 10 as viewed from the X-axis positive direction. It is noted that FIG. 8 illustrates a cross section of the lid part 120.

As illustrated in FIGS. 7 and 8, the HMD 10 according to the first embodiment of the present disclosure includes the head mount device 100 and the portable display device 200. The head mount device 100 includes the main body part 110, the lid part 120, and the light guidance unit 130.

### 1.3.1. Head Mount Device

As illustrated in FIG. 7, the lid part 120 is provided with an incident port 131 through which light enters. In the example of FIG. 7, the incident port 131 is provided at substantially the center in the longitudinal direction (the X-axis direction) of the lid part 120, and is provided at one end in the lateral direction (the Y-axis direction) of the lid part 120. For example, in a mounting state in which the HMD 10 is mounted on the user U, the incident port 131 is provided in the vicinity of a position corresponding to the glabella of the user U.

The light guidance unit 130 guides the incident port incident on the incident port 131 to the image sensor 212. The light guidance unit 130 includes, for example, at least one concave mirror and a total reflection surface. The light guidance unit 130 includes a combination of optical members such as a prism, a mirror, and a lens. The light guidance unit 130 is formed of, for example, a transparent material such as resin or glass.

For example, the light guidance unit 130 is disposed such that one end thereof covers the image sensor 212 mounted on the portable display device 200 and the other end thereof is positioned at the incident port 131 of the lid part 120.

Here, in general, a camera module including the imaging device 211, the image sensor 212, and the like is disposed to be biased to any side of the housing of the portable display device 200 due to structural constraints in design. For example, in the example of FIG. 7, the camera module is disposed on the upper right side of the portable display device 200.

Therefore, as illustrated in FIGS. 7 and 8, the light guidance unit 130 is configured to guide light incident from the incident port 131 in the X-axis positive direction, thereby guiding the incident light from the incident port 131 to the image sensor 212. That is, the light guidance unit 130 is configured to guide the angle of view of the image sensor 212 to the center side (the X-axis negative direction) of the lid part 120 in the horizontal direction.

It is noted that FIG. 7 illustrates a case in which the incident port 131 is exposed and the camera module is not exposed, but the present disclosure is not limited thereto. For example, an opening part may be provided in the lid part 120 so as to expose at least a part of the camera module. For example, the second and third imaging devices 211B and 211C are exposed.

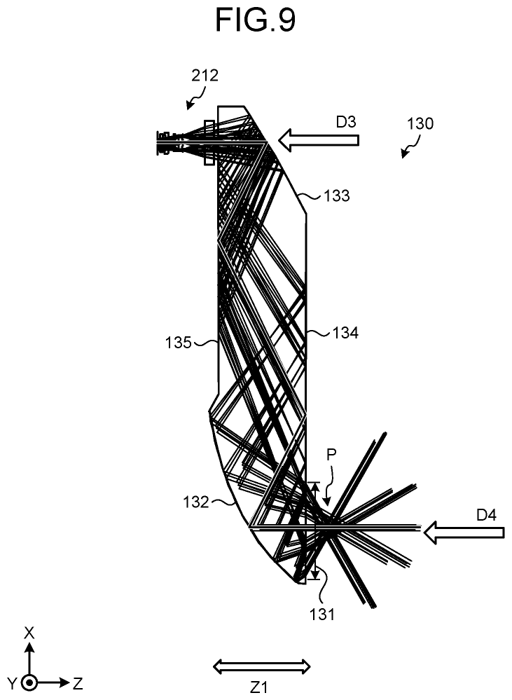

FIG. 9 is a schematic diagram illustrating a configuration example of the light guidance unit 130 according to the first embodiment of the present disclosure. FIG. 9 illustrates the light guidance unit 130 as viewed from above (the Y-axis positive direction). In the example illustrated in FIG. 9, the light guidance unit 130 includes concave mirrors 132 and 133 and total reflection surfaces 134 and 135. The light guidance unit 130 is configured to form an entrance pupil near the incident port 131.

In the example of FIG. 9, the concave mirror 132 is provided at one end of the light guidance unit 130, for example, on the incident port 131 side. The concave mirror 133 is provided at the other end of the light guidance unit 130, for example, on the image sensor 212 side. The total reflection surfaces 134 and 135 are provided between the concave mirrors 132 and 133 so as to face each other, for example, substantially parallel to each other. The concave mirrors 132 and 133 having a small incident angle of light beams can be configured as, for example, vapor deposition mirrors.

Light incident from an incident direction D4 is condensed by the concave mirror 132 and is guided by the total reflection surfaces 134 and 135. The light is guided by the concave mirror 133 while being totally reflected by the total reflection surfaces 134 and 135. The light reflected by the concave mirror 133 is emitted from an emission direction D3 while being condensed, and is incident on the image sensor 212.

As described above, the light guidance unit 130 has a function of guiding and condensing the incident light by total reflection. More specifically, the total reflection surfaces 134 and 135 have a function of guiding light beams. The concave mirrors 132 and 133 have a function of condensing incident light (a function of increasing the angle of view) as a lens in addition to a function of guiding a light beam direction.

As a result, the light guidance unit 130 can move the optical axis of the angle of view of the sensor downwards in FIG. 9 (the X-axis negative direction) while increasing the angle of view of the sensor of the image sensor 212.

Furthermore, by configuring the light guidance unit 130 using a prism, a depth Z1 of the light guidance unit 130 can be reduced as compared with a case of configuring the light guidance unit 130 by combining optical members such as a mirror and a lens. Accordingly, the depth (the length in the Z-axis direction) of the lid part 120, that is, the size of the head mount device 100 in the forward-and-rearward direction can be reduced.

It is noted that the configuration of the light guidance unit 130 illustrated in FIG. 9 is an example, and the present disclosure is not limited thereto. For example, in FIG. 9, the light reflected by the concave mirror 132 is totally reflected twice in total, once on each of the total reflection surfaces 134 and 135, and the light is incident on the concave mirror 133, but the number of times of total reflection is not limited thereto. Light may be totally reflected on the total reflection surfaces 134 and 135 three or more times in total.

Alternatively, the light guidance unit 130 may not include the total reflection surfaces 134 and 135. In this case, the light guidance unit 130 condenses and guides incident light using the concave mirrors 132 and 133. The number of times of total reflection of the incident light on the total reflection surfaces 134 and 135, that is, the lengths of the total reflection surfaces 134 and 135 can be changed depending on a distance between the incident port 131 and the image sensor 212 and a function of guiding the light of the concave mirrors 132 and 133.

Furthermore, here, the other end of the light guidance unit 130, for example, a mirror on the image sensor 212 side is a concave mirror, but the present disclosure is not limited thereto. At least one end of the light guidance unit 130, for example, the mirror on the incident side may be a concave mirror, and the mirror on the image sensor 212 side may be a total reflection mirror.

Furthermore, FIG. 9 illustrates a case in which the emission direction D3 and the incident direction D4 of the light guidance unit 130 are parallel to each other, that is, the incident direction D4 is the line-of-sight direction of the user U, but the present disclosure is not limited thereto. The incident direction D4 may be inclined downwards (the Y-axis negative direction) more than the emission direction D3 (refer to the direction D2 in FIG. 6).

### 1.3.2. Portable Display Device

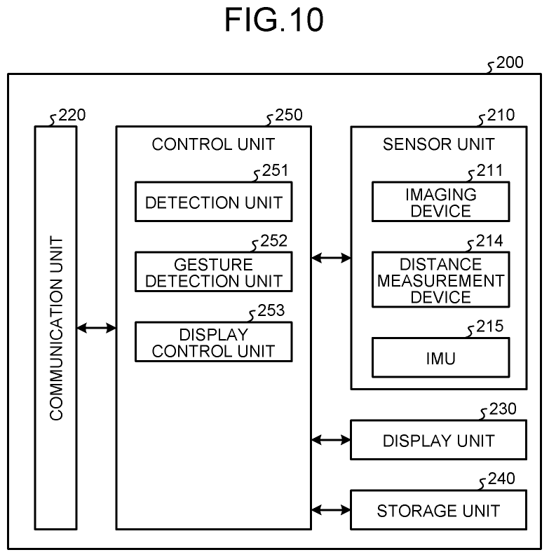

FIG. 10 is a block diagram illustrating a configuration example of the portable display device 200 according to the first embodiment of the present disclosure.

As described above, the portable display device 200 is a small information processing device including a display unit and a sensor unit, such as a smartphone or a portable game machine.

As illustrated in FIG. 10, the portable display device 200 includes a sensor unit 210, a communication unit 220, a display unit 230, a storage unit 240, and a control unit 250.

### [Sensor Unit 210]

The sensor unit 210 includes various sensors that detect the state of the user or the surrounding environment of the user. The sensor unit 210 outputs sensing data acquired by these various sensors to the control unit 250 described later.

The sensor unit 210 illustrated in FIG. 10 includes an imaging device 211, a distance measurement device 214, and an inertial measurement unit (IMU) 215. Furthermore, in addition to these sensors, the sensor unit 210 can include various sensors such as a positioning sensor that measures the position of the user and a microphone that detects environmental sound around the user.

### (Imaging Device 211)

Although not illustrated, the imaging device 211 includes, for example, a lens, a light receiving element, and an information processing circuit. The lens guides the light incident from the light guidance unit 130 to the light receiving element. The light receiving element photoelectrically converts the light passing through the lens to generate a pixel signal. The light receiving element is, for example, a complementary metal oxide semiconductor (CMOS) type image sensor, and a color photographable element having a Bayer array is used. It is noted that, as the light receiving element, for example, a light receiving element capable of coping with photographing of a high-resolution image of 4K or more may be used.

A signal processing circuit processes an analog pixel signal output from the light receiving element. The signal processing circuit converts light entering from the lens into digital data (image data). The signal processing circuit outputs the converted image data to the control unit 250. It is noted that the image captured by the imaging device 211 is not limited to a video (a moving image), and the image may be a still image.

Furthermore, a plurality of imaging devices 211 may be provided. As described above, the portable display device 200 may include the first to third imaging devices 211A to 211C (refer to FIG. 2). The first to third imaging devices 211A to 211C can be imaging devices having different angles of view (for example, standard, zoom, wide angle, and the like).

### (Distance Measurement Device 214)

The distance measurement device 214 includes the image sensor 212, the light source 213 (refer to FIG. 2), and a distance measurement control unit (not illustrated).

The light source 213 emits, for example, infrared light to a subject at a timing according to control from the distance measurement control unit. The image sensor 212 is, for example, a complementary metal oxide semiconductor (CMOS) type image sensor, and detects infrared light. The image sensor 212 receives reflected light obtained by reflecting light emitted from the light source 213 by the subject. The distance measurement control unit calculates a distance to the subject based on an emission timing of the light source 213 and a light reception timing of the image sensor 212. The distance measurement control unit outputs data (distance data) of the calculated distance to the control unit 250.

### (IMU 215)

The IMU 215 is an inertial measurement unit that acquires sensing data (inertial data) indicating changes in acceleration and angular velocity caused by a motion of the user. The IMU 215 includes an acceleration sensor, a gyro sensor, a geomagnetic sensor, and the like (not illustrated). The IMU 215 outputs the acquired completion data to the control unit 250.

### [Communication Unit 220]

The communication unit 220 is a communication interface for communicating with other devices. The communication unit 220 may include a network interface or a device connection interface.

For example, the communication unit 220 may include a LAN interface such as a network interface card (NIC), or may include a USB interface configured by a universal serial bus (USB) host controller, a USB port, or the like. Furthermore, the communication unit 220 may include a wired interface or a wireless interface. For example, the communication unit 220 acquires a video to be displayed on the display unit 230 from a cloud server (not illustrated) via the Internet according to the control of the control unit 250.

### [Display Unit 230]

The display unit 230 is, for example, a panel-type display device such as a liquid crystal panel or an organic electro luminescence (EL) panel. The display unit 230 displays a moving image or a still image rendered by the control unit 250 to be described later. It is noted that the display unit 230 may be a touch-panel-type display device. In this case, the display unit 230 also functions as an input unit.

### [Storage Unit 240]

The storage unit 240 is a data readable/writable storage device such as a dynamic random access memory (DRAM), a static random access memory (SRAM), a flash memory, or a hard disk. The storage unit 240 functions as a storage unit of the portable display device 200.

### [Control Unit 250]

The control unit 250 integrally controls the operation of the portable display device 200 using, for example, a CPU, a graphics processing unit (GPU), a RAM, and the like built in the portable display device 200. For example, the control unit 250 is implemented by allowing a processor to execute various programs stored in the storage device inside the portable display device 200 using a random access memory (RAM) or the like as a work region. It is noted that the control unit 250 may be implemented by an integrated circuit such as an application specific integrated circuit (ASIC) or a field programmable gate array (FPGA). Any of the CPU, the MPU, the ASIC, and the FPGA can be regarded as a controller.

Furthermore, the control unit 250 functions as an application control unit when an application program operates on, for example, the central processing unit (CPU) or the GPU. In this case, the control unit 250 functioning as the application control unit executes processing of rendering an image to be displayed on the display unit 230, processing of detecting a position of a user's hand, a gesture, and the like.

As illustrated in FIG. 10, the control unit 250 includes a detection unit 251, a gesture detection unit 252, and a display control unit 253. Each block (the detection unit 251 to the display control unit 253) constituting the control unit 250 is a functional block indicating a function of the control unit 250. These functional blocks may be software blocks or hardware blocks. For example, each of the functional blocks described above may be one software module implemented by software (including a microprogram), or may be one circuit block on a semiconductor chip (die). Of course, each functional block may be one processor or one integrated circuit. A configuration method of the functional block is freely selected. It is noted that the control unit 250 may be configured by a functional unit different from the above-described functional block.

### (Detection Unit 251)

The detection unit 251 detects the position and posture (shape) (hereinafter, also described as hand information) of the hand of the user U based on distance data detected by the distance measurement device 214. At this time, the detection unit 251 acquires the hand information of the user U by correcting the distance data according to the change of the angle of view of the sensor and the attenuation of light by the light guidance unit 130.

For example, the light guidance unit 130 described with reference to FIGS. 7 and 9 expands the angle of view of the sensor and moves the optical axis of the angle of view of the sensor in the horizontal direction (the X-axis direction). If the detection unit 251 detects the shape of the hand of the user U by using the distance data detected by the distance measurement device 214 as it is without correcting the distance data, there is a possibility that the hand having a shape larger than the actual shape of the hand of the user U is erroneously detected. Furthermore, if the detection unit 251 detects the position of the hand of the user U without correcting the distance data, there is a possibility that a position shifted in the horizontal direction from the actual position of the hand is erroneously detected.

Furthermore, light incident on the image sensor 212 via the light guidance unit 130 is attenuated by the light guidance unit 130. Therefore, when the detection unit 251 detects the position of the hand of the user U without correcting the distance data, there is a possibility that a position different from the actual position of the hand is erroneously detected.

The description returns to FIG. 10. Therefore, the detection unit 251 corrects the distance data detected by the distance measurement device 214 according to a structure, an attenuation rate, and the like of the light guidance unit 130, and detects a subject (the hand of the user U) around the user U based on the corrected distance data. The detection unit 251 outputs the hand information regarding the detected hand of the user U to the gesture detection unit 252.

Here, the detection unit 251 corrects (calibrates) the distance data using correction information. The correction information is, for example, distance data in which the direction and the angle of the angle of view of the sensor are changed by the light guidance unit 130, and is a recognition algorithm for correctly recognizing the distance data generated by an attenuated signal. The correction information is, for example, information determined corresponding to the distance measurement device 214 and the light guidance unit 130 (or the head mount device 100). The correction information can include, for example, coordinate transformation information for coordinate-transforming distance data of each pixel of the image sensor 212 into the real space in which the user U exists.

The detection unit 251 acquires distance measurement device information regarding the distance measurement device 214 from, for example, a distance measurement control unit (not illustrated) of the distance measurement device 214. Alternatively, the detection unit 251 may acquire the distance measurement device information stored in the storage unit 240.

The detection unit 251 acquires, for example, light guidance information related to the light guidance unit 130. For example, the detection unit 251 receives an input of the light guidance information related to the light guidance unit 130 from the user U. Alternatively, in a case where the light guidance information is associated with an application executed by the portable display device 200, the detection unit 251 acquires the light guidance information by acquiring application information related to the application. Furthermore, in a case where the portable display device 200 and the light guidance information are associated with each other, the detection unit 251 acquires the light guidance information by acquiring device information regarding the portable display device 200.

The detection unit 251 acquires the correction information corresponding to the distance measurement device information and the light guidance information from, for example, the storage unit 240 or an external device. In this case, it is assumed that the correction information is calculated in advance based on simulation, experiment, or the like, and is stored in the storage unit 240 or the external device.

Alternatively, the detection unit 251 may calculate the correction information. For example, the detection unit 251 calculates the correction information by using object information on an object (for example, a controller or the like), the shape and the position of which are known, and distance data obtained by detecting the object by the distance measurement device 214.

For example, if the object is a controller, the actual shape of the controller is known. In addition, the detection unit 251 detects the actual position of the controller using a sensor or the like mounted on the controller. For example, the detection unit 251 calculates the correction information by comparing the position and the shape of the object calculated from the distance data with the actual position and the shape of the controller. It is noted that the detection unit 251 may detect the position and the shape of the object using the imaging device 211.

### (Gesture Detection Unit 252)

The gesture detection unit 252 detects a gesture of the user U. For example, the gesture detection unit 252 detects a gesture according to a temporal change of the hand information detected by the detection unit 251. The gesture detection unit 252 detects, for example, scanning performed by the user U with a gesture, such as a tap operation or a slide operation by the user U. The gesture detection unit 252 outputs operation information regarding an operation by the detected gesture to the display control unit 253.

### (Display Control Unit 253)

The display control unit 253 generates an image and causes the display unit 230 to display the image. For example, the display control unit 253 renders the image according to the position and the posture of the head of the user U based on the inertial data detected by the IMU 215. The display control unit 253 causes the display unit 230 to display the rendered image.

Furthermore, the display control unit 253 generates the image based on the operation information detected by the gesture detection unit 252. For example, it is assumed that the user U taps a thumbnail image and selects a video to be reproduced next in a state where the thumbnail images of the plurality of videos, which are reproduction candidates, are displayed as a menu screen. In this case, the gesture detection unit 252 detects a tap operation on the thumbnail image. The display control unit 253 displays a video corresponding to the thumbnail image on the display unit 230 based on the tap operation detected by the gesture detection unit 252.

As described above, the head mount device 100 according to the first embodiment of the present disclosure includes the housing (the main body part 110 and the lid part 120) and the light guidance unit 130. The housing is configured to fix the portable display device 200 thereto. The light guidance unit 130 is configured to change the angle of view of the image sensor 212 so as to allow the image sensor 212 mounted on the portable display device 200 to sense at least the lower region (the Y-axis negative direction) below the line-of-sight direction (the Z-axis direction) of the user U in a mounting state in which the portable display device 200 is fixed to the housing and the housing is mounted on the user U.

Thus, the head mount device 100 can sense the state (in particular, the hand of the user U) around the user U using the image sensor 212 mounted on the portable display device 200 without mounting a new sensor. This eliminates the need for the user U to greatly move the hand. Furthermore, the HMD 10 can further reduce a deviation between the HMD viewing angle and the angle of view of the sensor, particularly at the hand of the user U. As described above, the head mount device 100 according to the first embodiment of the present disclosure can further reduce the burden on the user U.

### 1.4. Modification

In the first embodiment described above, the head mount device 100 has a configuration in which the lid part 120 to which the portable display device 200 is fixed is mounted on the main body part 110, but the present disclosure is not limited thereto. The head mount device 100 can take various configurations as shown in the following modifications.

### 1.4.1. First Modification

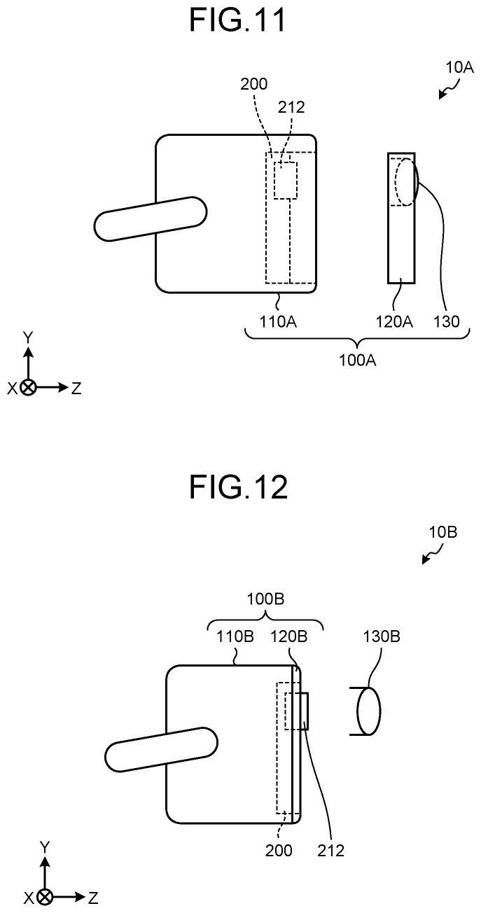

FIG. 11 is a schematic diagram illustrating a configuration example of an HMD 10A according to a first modification of the first embodiment of the present disclosure.

As illustrated in FIG. 11, a head mount device 100A of the HMD 10A includes a main body part 110A, a lid part 120A, and the light guidance unit 130. The main body part 110A is configured to be able to fix the portable display device 200 thereto.

As described above, the head mount device 100A according to the present modification is different from the head mount device 100 in which the lid part 120 is configured to be able to store the portable display device 200 in that the main body part 110A is configured to be able to store the portable display device 200.

The lid part 120A is configured to be attachable to and detachable from the main body part 110A. The lid part 120A is mounted on, for example, the main body part 110A to which the portable display device 200 is fixed. The light guidance unit 130 is mounted on the lid part 120A.

### 1.4.2. Second Modification

FIG. 12 is a schematic diagram illustrating a configuration example of an HMD 10B according to a second modification of the first embodiment of the present disclosure.

As illustrated in FIG. 12, the HMD 10B includes a head mount device 100B, a light guidance device 130B, and the portable display device 200. The head mount device 100B includes a main body part 110B and a lid part 120B. The main body part 110B is configured to be able to fix the portable display device 200 thereto. The lid part 120B is configured to allow the image sensor 212 of the portable display device 200 to be exposed. The lid part 120B is configured to be attachable to and detachable from the main body part 110B.

The light guidance device 130B is configured to be attachable to and detachable from the lid part 120B. The light guidance device 130B is mounted on, for example, a portion of the lid part 120B, in which the image sensor 212 of the portable display device 200 is exposed at the portion. Since the configuration of the light guidance device 130B is the same as that of the light guidance unit 130, a description thereof will be omitted.

### 1.4.3. Third Modification

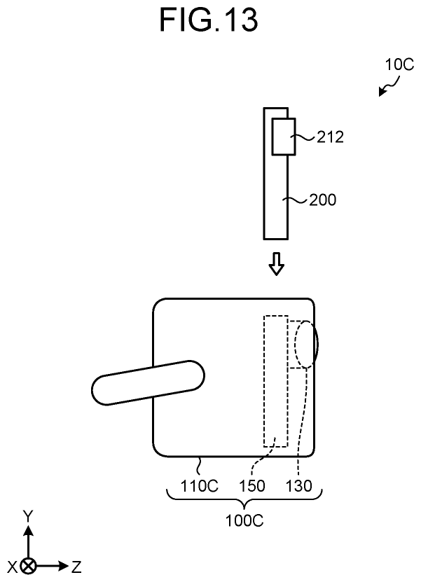

FIG. 13 is a schematic diagram illustrating a configuration example of an HMD 10C according to a third modification of the first embodiment of the present disclosure.

As illustrated in FIG. 13, the HMD 10C includes a head mount device 100C and the portable display device 200. The head mount device 100C includes a storage part 150 capable of storing the portable display device 200, and the light guidance unit 130. The head mount device 100C is different from the head mount devices 100, 100A, and 100B in that the lid part 120 is not provided.

The head mount device 100C may have an opening part (not illustrated) configured to allow the portable display device 200 to be inserted into the storage part 150. In the example of FIG. 13, the head mount device 100C has the opening part in an upper portion (the Y-axis positive direction). The portable display device 200 is stored in the storage part 150 through the opening part.

### 2. Second Embodiment

In the first embodiment described above, the light guidance unit 130 changes the angle of view of the image sensor 212, but the present disclosure is not limited thereto. For example, the light guidance unit 130 may change at least one of the irradiation range and the irradiation direction of the irradiation light of the light source 213, in addition to the angle of view of the image sensor 212.

The light source 213 emits infrared light used for distance measurement in the image sensor 212. Therefore, in general, the irradiation range of the light source 213 can be set to be substantially the same as the angle of view of the image sensor 212. Therefore, in a case where light emitted from the light source 213 is not particularly changed, there is a possibility that the light source 213 cannot illuminate the hand of the user U.

Therefore, the HMD 10 according to the second embodiment changes at least one of the irradiation range and the irradiation direction of the irradiation light of the light source 213 in addition to the angle of view of the image sensor 212.

### 2.1. Case of Changing Both Angle of View and Irradiation Light with One Light Guidance Unit

Examples of a method of changing the irradiation light of the light source 213 include a method of changing the irradiation light using the light guidance unit 130 that changes the angle of view of the image sensor 212.

The light guidance unit 130 is configured to change the angle of view of the sensor so as to allow the image sensor 212 to sense at least a lower region below the line-of-sight direction of the user, and to change the light emitted from the light source 213 downwards more than the line-of-sight direction of the user.

In this case, the light guidance unit 130 is configured such that one end thereof covers both the image sensor 212 and the light source 213. The light guidance unit 130 guides both incident light to the image sensor 212 and irradiation light from the light source 213. Therefore, the size of the light guidance unit 130 is larger than that of a case of guiding the incident light to the image sensor 212.

### 2.2. Case of Changing Angle of View and Irradiation Light Using Different Light Guidance Units

As described above, if both the incident light on the image sensor 212 and the irradiation light from the light source 213 are guided using one light guidance unit 130, the size of the light guidance unit 130 increases. In particular, the size of the HMD 10 in the depth direction (the Z-axis direction) may increase.

Therefore, in the second embodiment of the present disclosure, the head mount device 100 includes the light guidance unit 130 that guides the incident light to the image sensor 212 and a light guidance unit 140 that guides the irradiation light from the light source 213. It is noted that, hereinafter, the light guidance unit 130 that guides the incident light on the image sensor 212 is also referred to as a first light guidance unit 130. Further, the light guidance unit 140 that guides the irradiation light from the light source 213 is also referred to as a second light guidance unit 140.

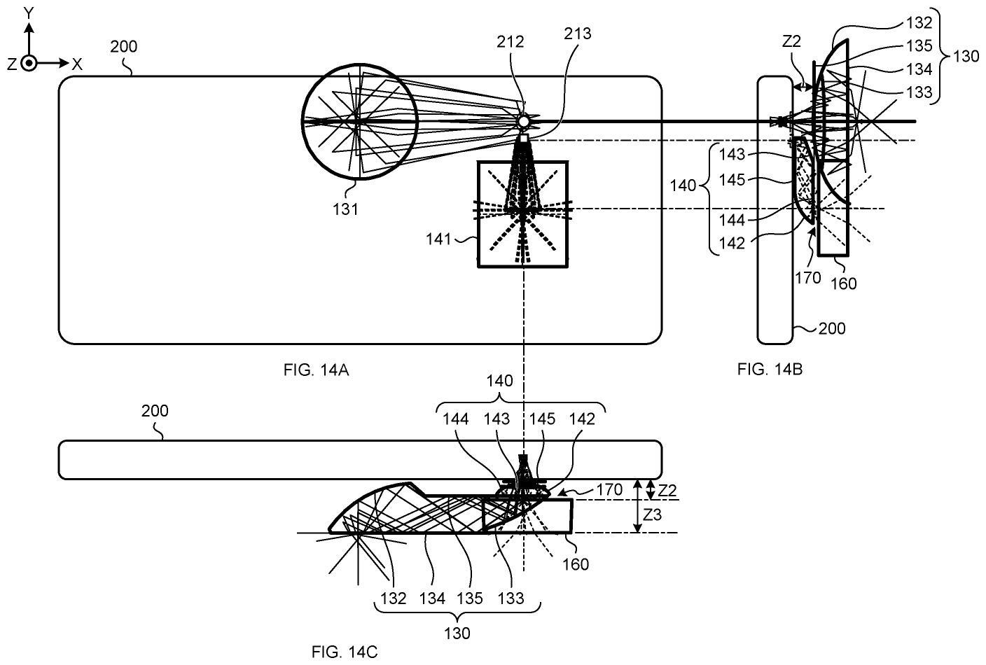

FIG. 14 is a diagram illustrating light guided by the first and second light guidance units 130 and 140 according to the second embodiment of the present disclosure. In FIG. 14, in order to simplify the drawing, illustration of a component unnecessary for description, such as a housing, is omitted. Furthermore, in FIG. 14, in order to facilitate visual recognition of the reflection surfaces (the concave surface of the concave mirror and the total reflection surface) of the first and second light guidance units 130 and 140, these reflection surfaces are illustrated, and illustration of the first and second light guidance units 130 and 140 themselves may be omitted. Further, in FIG. 14, the light guided by the first light guidance unit 130 is indicated by a solid line, and the light guided by the second light guidance unit 140 is indicated by a dotted line.

It is noted that FIG. 14(a) is a diagram illustrating the first and second light guidance units 130 and 140 and the portable display device 200 as viewed from the front (the Z-axis positive direction). FIG. 14(b) is a diagram illustrating the first and second light guidance units 130 and 140 and the portable display device 200 as viewed from the lateral direction (the X-axis positive direction). FIG. 14(c) is a diagram illustrating the first and second light guidance units 130 and 140 and the portable display device 200 as viewed in the longitudinal direction (the Y-axis positive direction).

As illustrated in FIG. 14, the light incident on the first light guidance unit 130 from the incident port 131 is condensed and guided by the first light guidance unit 130, and is emitted to the image sensor 212. It is noted that the configuration of the first light guidance unit 130 is the same as that of the light guidance unit 130 illustrated in FIG. 9. The first light guidance unit 130 guides the incident light in the horizontal direction (the X-axis positive direction).

The second light guidance unit 140 diffuses and guides the light emitted from the light source 213, and emits the light from an emission port 141. The second light guidance unit 140 includes, for example, at least one concave mirror and a total reflection surface. In the example of FIG. 14, the second light guidance unit 140 includes concave mirrors 142 and 143 and total reflection surfaces 144 and 145. Since the second light guidance unit 140 can be configured similarly to the first light guidance unit 130, a description thereof is omitted here.

The first light guidance unit 130 and the second light guidance unit 140 are arranged such that the light incident on the image sensor 212 and the light emitted from the light source 213 do not interfere with each other.

For example, as described above, the first light guidance unit 130 is disposed so as to guide light in the horizontal direction (an example of a first guidance direction). On the other hand, the second light guidance unit 140 is disposed so as to guide light in the vertical direction (examples of the Y-axis negative direction and a second guidance direction) different from the horizontal direction.

It is noted that the direction in which the first light guidance unit 130 and the second light guidance unit 140 guide light is not limited thereto. The first light guidance unit 130 and the second light guidance unit 140 are only required to guide light so as not to interfere with each other, and for example, the second light guidance unit 140 may guide the irradiation light in a direction opposite the first light guidance unit 130 (the X-axis negative direction).

Further, the directions in which the first and second light guidance units 130 and 140 guide light are not limited to the horizontal and vertical directions. The first and second light guidance units 130 and 140 may guide light in any direction. For example, the first light guidance unit 130 may guide light incident from an opening part formed at the center (substantially the center in the longitudinal direction and substantially the center in the lateral direction) of the lid part 120 to the image sensor 212 disposed at the corner portion of the portable display device 200. In this case, the first light guidance unit 130 guides the light in an oblique direction (a diagonal direction of the portable display device 200).

Furthermore, for example, the first light guidance unit 130 and the second light guidance unit 140 are arranged to be shifted (offset) so that guided light beams do not interfere with each other. In the example of FIG. 14, the first light guidance unit 130 is disposed at an interval (offset) of a distance 22 in the line-of-sight direction (the Z-axis positive direction) from the second light guidance unit 140.

Thus, the head mount device 100 can further reduce interference between the light that is emitted from the light source 213 and is incident on the second light guidance unit 140 and the light that is emitted from the first light guidance unit 130 and is incident on the image sensor 212.

In order to avoid interference of the light beams respectively guided by the first and second light guidance units 130 and 140, the head mount device 100 further includes a third light guidance unit 160.

The third light guidance unit 160 is disposed between the surface from which the irradiation light of the second light guidance unit 140 is emitted and the emission port 141. The third light guidance unit 160 is configured to shift (guide) the irradiation light emitted from the second light guidance unit 140 to the emission port 141. The third light guidance unit 160 is made of a transparent member such as resin or glass. The third light guidance unit 160 has a refractive index larger than 1. Furthermore, an air layer 170 may be provided between the second light guidance unit 140 and the third light guidance unit 160. The second light guidance unit 140 and the third light guidance unit 160 may be configured as separate members, or may be configured as one integrally formed member.

As described above, the first and second light guidance units 130 and 140 are disposed in an offset manner. In addition, the first and second light guidance units 130 and 140 have different sizes. Therefore, the height of the surface on which light is incident on the first light guidance unit 130 and the height of the surface from which light is emitted from the second light guidance unit 140 may be different from each other.

For example, as illustrated in FIG. 14(b), in the first light guidance unit 130, light is incident on the first light guidance unit 130 at the incident port 131. In the second light guidance unit 140, light is emitted from the second light guidance unit 140 at the back (the inner side of the lid part 120) of the emission port 141.

Therefore, in a case where the third light guidance unit 160 is not provided, the irradiation light emitted from the second light guidance unit 140 may interfere with the light guided by the first light guidance unit 130.

Therefore, in the second embodiment of the present disclosure, the third light guidance unit 160 guides the light emitted from the second light guidance unit 140 to the emission port 141. As described above, the third light guidance unit 160 has a refractive index larger than that of the air layer 170. Therefore, the light emitted from the second light guidance unit 140 is refracted and incident so as to be condensed from one end of the third light guidance unit 160 via the air layer 170.

Light traveling straight through the third light guidance unit 160 is emitted from the other end of the third light guidance unit 160. The emission port 141 is exposed to the external space, and the other end of the third light guidance unit 160 is in contact with the outside air (air). Therefore, the light is refracted and emitted so as to be diffused from the other end of the third light guidance unit 160. The angle of the light emitted from the other end of the third light guidance unit 160 is substantially the same angle (wide angle) as the angle of the light emitted from the second light guidance unit 140 to the air layer 170.

As described above, by providing the first and second light guidance units 130 and 140, the head mount device 100 can change at least one of the irradiation range and the irradiation direction of the irradiation light of the light source 213 while changing the angle of view of incident light on the image sensor 212.

The head mount device 100 guides the incident light to the image sensor 212 and the irradiation light from the light source 213 using the first and second light guidance units 130 and 140, respectively. As a result, the first and second light guidance units 130 and 140 can select an optimum configuration according to the light to be guided. Therefore, the head mount device 100 can reduce the sizes of the first and second light guidance units 130 and 140 as compared with a case in which two light beams are guided by one light guidance unit. In particular, the head mount device 100 can make the thickness of the lid part 120 (refer to Z3 in FIG. 14(c)) thinner in the depth direction (the Z-axis direction) than a case in which two light beams are guided by one light guidance unit.

In addition, the first and second light guidance units 130 and 140 are configured and arranged to guide light beams in directions different from each other. The first and second light guidance units 130 and 140 are arranged in a state of being offset from each other. Further, the head mount device 100 guides the light emitted from the second light guidance unit 140 to the emission port 141 using the third light guidance unit 160.

Thus, the head mount device 100 can guide each light in a predetermined direction while condensing or diffusing each light without interfering the incident light on the image sensor 212 and the irradiation light from the light source 213.

It is noted that, in FIG. 14, in order to make it easy to distinguish between the image sensor 212 and the light source 213, the image sensor 212 is illustrated as a circle, and the light source 213 is illustrated as a square. Similarly, the incident port 131 is indicated as a circle, and the emission port 141 is indicated as a square. However, these shapes are not limited to a circle or a square. All of these shapes may be a circle or a square. Alternatively, these shapes may be any shape such as an ellipse.

In addition, here, the first and second light guidance units 130 and 140 are disposed to be offset from each other by disposing the first light guidance unit 130 at an interval of the distance Z2 in the line-of-sight direction (the Z-axis positive direction) from the second light guidance unit 140, but the present disclosure is not limited thereto. For example, the first and second light guidance units 130 and 140 may be disposed to be offset from each other by disposing the second light guidance unit 140 to be shifted in the line-of-sight direction (the Z-axis positive direction) from the first light guidance unit 130.

In addition, here, the third light guidance unit 160 guides the light emitted from the second light guidance unit 140 to the emission port 141, but the present disclosure is not limited thereto. For example, the third light guidance unit 160 may guide the light incident on the incident port 131 to the first light guidance unit 130. In this case, the third light guidance unit 160 is disposed between the first light guidance unit 130 and the incident port 131. At this time, an air layer may be provided between the third light guidance unit 160 and the first light guidance unit 130.

### 3. Third Embodiment

In the first and second embodiments described above, the HMD 10 further reduces a deviation between the position of the hand recognized by the user U by the optical approach using the light guidance unit 130 and the position of the hand detectable by the HMD 10. In the third embodiment, a description will be given as to a method in which a portable display device 200A of the HMD 10 reduces the deviation therebetween by changing a UI.

For example, the portable display device 200 according to the third embodiment of the present disclosure presents, to the user U, an image around a region corresponding to the angle of view (detection range) of the image sensor 212.

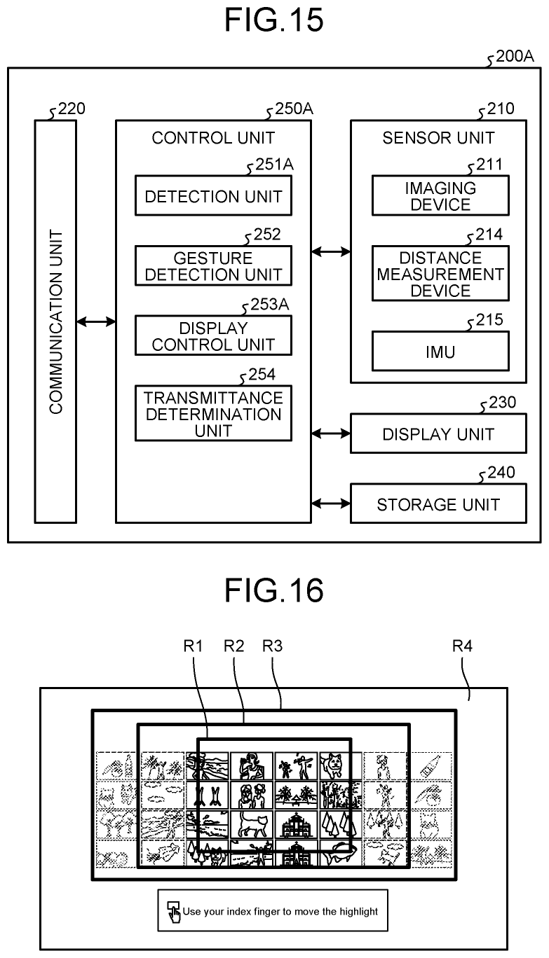

FIG. 15 is a block diagram illustrating a configuration example of the portable display device 200A according to the third embodiment of the present disclosure. A control unit 250A of the portable display device 200A illustrated in FIG. 15 includes a transmittance determination unit 254. Further, the control unit 250A includes a detection unit 251A instead of the detection unit 251. Other configurations and operations are the same as those of the portable display device 200 illustrated in FIG. 10, and thus, the same reference numerals are assigned thereto so as to omit a description thereof. Furthermore, the HMD 10 according to the third embodiment of the present disclosure is different from the HMD 10 illustrated in FIGS. 8 and 9 in that the light guidance unit 130 is not provided (refer to FIGS. 1 and 2).

As described above, the HMD 10 according to the present embodiment does not include the light guidance unit 130. Therefore, the detection unit 251A illustrated in FIG. 15 directly detects an object (for example, the hand of the user U) without correcting distance measurement data detected by the distance measurement device 214.

The transmittance determination unit 254 determines different transmittances (transmissivity) in a first region corresponding to the detection range of the image sensor 212 and a second region corresponding to the periphery of the detection range of the image sensor 212 in the image generated by the display control unit 253. For example, the transmittance determination unit 254 sets each transmittance such that a transmittance of the second region (an example of a first transmittance) is higher than a transmittance of the first region (an example of a second transmittance). That is, the transmittance determination unit 254 determines the transmittance such that the background is more transparent and is displayed lighter in the second region. The transmittance determination unit 254 displays an image with the determined transmittance.

FIGS. 16 to 18 are diagrams illustrating the transmittance determined by the transmittance determination unit 254 according to the third embodiment of the present disclosure. FIGS. 16 to 18 illustrate a case in which the portable display device 200A displays a menu image including a plurality of thumbnail images of reproduction candidate videos on the display unit 230.

In the example illustrated in FIG. 16, the transmittance determination unit 254 divides the menu image into three regions (first to fourth regions R1 to R4), and determines different transmittances in the respective regions. The first region R1 is a region corresponding to the detection range of the image sensor 212. The second region R2 is a region around the first region R1. The third region R3 is a region around the second region R2. The fourth region R4 is a region around the third region R3.

The first region R1 may be, for example, a region narrower than the detection range of the image sensor 212. In this case, the first region R1 is a region in which the image sensor 212 can detect an object (for example, the hand of the user U) with higher accuracy. Hereinafter, the first region R1 is also referred to as a detection recommended area.

The second region R2 is a region that is within the detection range of the image sensor 212, but the same has lower object detection accuracy than that of the first region R1. Hereinafter, the second region R2 is also referred to as a detection intermediate area.

The fourth region R4 is, for example, a region outside the detection range of the image sensor 212. In the fourth region R4, the image sensor 212 cannot detect the object. Hereinafter, the fourth region R4 is also referred to as a non-detection area.

The third region R3 is a region that is within the detection range of the image sensor 212, but the same is adjacent to the non-detection area. Therefore, the detection accuracy of the image sensor 212 in the third region R3 is lower than that in the second region R2. Hereinafter, the third region R3 is also referred to as a detection limit area.

The transmittance determination unit 254 determines the transmittance for each of the first to fourth regions R1 to R4. For example, the transmittance determination unit 254 sets the transmittance of the first region R1 to “0%”. That is, the background is not transmitted at all in the first region R1. The transmittance determination unit 254 sets the transmittance of the second region R2 to “25%”. That is, a part of the background is transmitted in the second region R2. The transmittance determination unit 254 sets the transmittance of the third region R3 to “50%”. That is, the background in the third region R3 is made to be more transparent than that in the second region R2. The transmittance determination unit 254 sets the transmittance of the fourth region R4 to “100%”. In fourth region R4, the background is displayed, and the thumbnail image is not displayed.

In this manner, the transmittance determination unit 254 changes the transmittance to display the image. That is, the portable display device 200A displays a clearer image in a space in which the hand can be recognized. In addition, the portable display device 200A displays an image, the color of which becomes lighter, as the detection accuracy decreases. The portable display device 200A does not display an image in a space in which the hand cannot be recognized. In other words, the portable display device 200A generates the UI (for example, the menu image) according to the space in which the hand can be recognized.

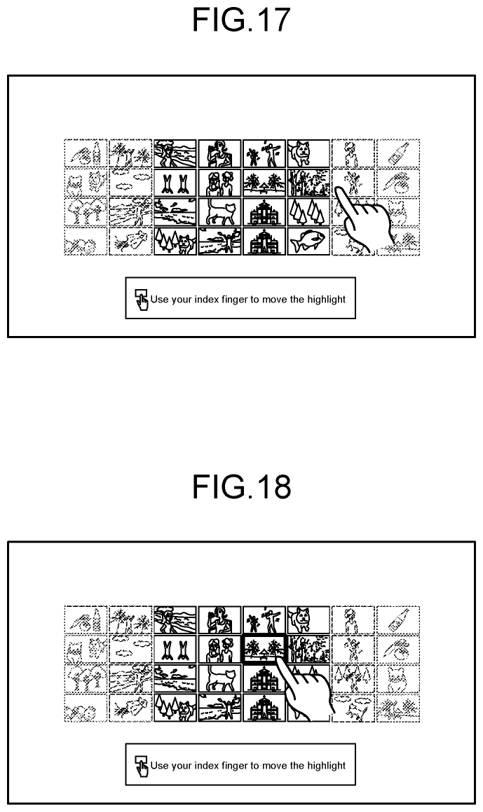

As illustrated in FIG. 17, in a case where the hand of the user U is located in a region (for example, the second region R2) in which the image is displayed in a light color, the thumbnail image is not selected. On the other hand, as illustrated in FIG. 18, in a case where the hand of the user U is located in a region in which the image is displayed in a dark color (for example, the first region R1), the thumbnail image corresponding to the position of the hand of the user U is selected.

In this way, by changing the transmittance and displaying the image, the user U can intuitively recognize whether the thumbnail image can be selected depending on the transmittance of the image. As a result, the portable display device 200A can further reduce a deviation between the position of the hand recognized by the user U in the virtual space and the position of the hand detectable by the HMD 10, thereby making it possible to further reduce the burden on the user U.

It is noted that the transmittance determination unit 254 sets each region in the content space to be presented to the user based on information on the angle of view of the image sensor 212. For example, the transmittance determination unit 254 sets each region based on the line-of-sight direction of the user U in the content space and the angle of view of the image sensor 212. The transmittance determination unit 254 acquires the information on the angle of view of the sensor based on, for example, information on the portable display device 200A or information on the image sensor 212.

Furthermore, the above-described value of the transmittance is an example, and the transmittance determination unit 254 may set a transmittance other than the above-described value. For example, the transmittance determination unit 254 may adjust the transmittance of each region according to a type of image to be displayed, such as whether to display a menu image or to reproduce a video.

In addition, FIG. 16 illustrates a case in which the transmittance determination unit 254 sets four regions in the image, but the present disclosure is not limited thereto. The transmittance determination unit 254 may set three or less regions, or may set five or more regions. The transmittance determination unit 254 may set two or more regions. The transmittance determination unit 254 may change the number of regions according to, for example, a type of image to be displayed.

Alternatively, the portable display device 200A may acquire a content, the region and the transmittance of which are determined in advance, and the transmittance determination unit 254 may display a content image according to the region and the transmittance determined in advance.

### 4. Fourth Embodiment

As described above, in the first to third embodiments, the user U fixes the portable display device 200 to the head mount device 100. Therefore, depending on how the portable display device 200 is mounted on the head mount device 100, variation (deviation) may occur between a user coordinate system and an HMD coordinate system.

In addition, the user U mounts, on the head, the head mount device 100 to which the portable display device 200 is fixed. Therefore, the variation (the deviation) may occur between the user coordinate system and the HMD coordinate system depending on a manner of mounting the head mount device 100.

Therefore, in the fourth embodiment of the present disclosure, a portable display device 200B detects each of a deviation due to the way the portable display device 200 is mounted on the head mount device 100 and a deviation due to the manner of mounting the head mount device 100. As a result, the portable display device 200B can correct the deviation, and display a rendered image according to the position and the posture of the head of the user U.

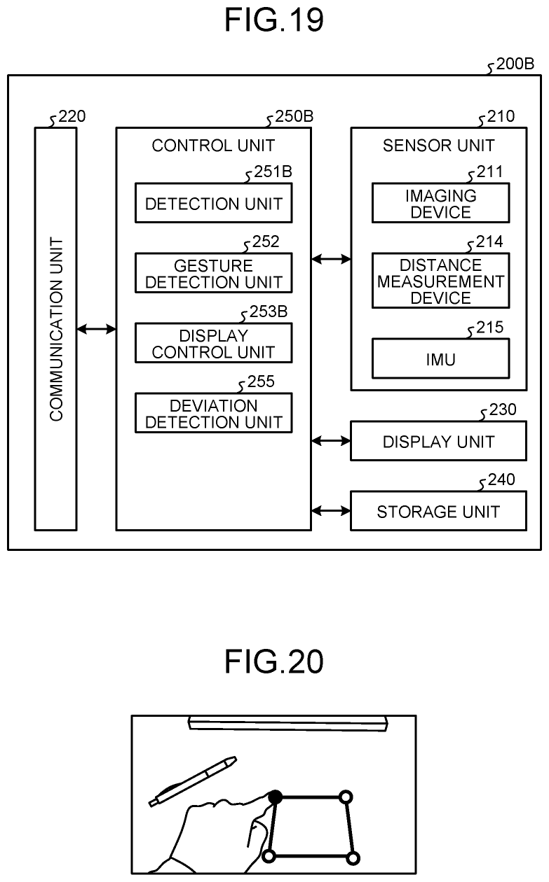

FIG. 19 is a block diagram illustrating a configuration example of the portable display device 200B according to the fourth embodiment of the present disclosure. A control unit 250B of the portable display device 200B illustrated in FIG. 19 includes a deviation detection unit 255. Furthermore, the control unit 250B includes a detection unit 251B instead of the detection unit 251, and includes a display control unit 253B instead of the display control unit 253. Other configurations and operations are the same as those of the portable display device 200 illustrated in FIG. 10, and thus, the same reference numerals are assigned thereto so as to omit a description thereof.

The deviation detection unit 255 detects a mounting deviation of the head mount device 100 with respect to the head and a mounting deviation of the portable display device 200B with respect to the head mount device 100.

For example, the deviation detection unit 255 detects the mounting deviation in the rotation direction using gravitational acceleration detected by the IMU 215. The deviation detection unit 255 outputs the detected mounting deviation to the display control unit 253B.

For example, the deviation detection unit 255 detects the mounting deviation of the portable display device 200B using input information input by the user U.

FIG. 20 is a diagram illustrating an example of a method of detecting the mounting deviation by the deviation detection unit 255 according to the fourth embodiment of the present disclosure. As illustrated in FIG. 20, for example, the user U designates a plurality of points on the same plane (for example, on the desk) with a finger or the like. The deviation detection unit 255 acquires the plurality of points designated by the user U as the input information. The deviation detection unit 255 detects the mounting deviation of the portable display device 200B by comparing the plane including the plurality of points designated by the user U with the detection result of the desk output by the image sensor 212. The deviation detection unit 255 outputs the detected mounting deviation to the detection unit 251B.

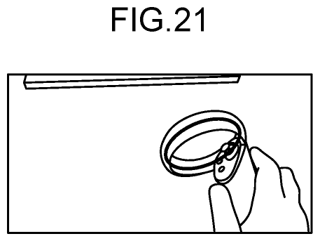

FIG. 21 is a diagram illustrating another example of the method of detecting the mounting deviation by the deviation detection unit 255 according to the fourth embodiment of the present disclosure. The deviation detection unit 255 performs detection using the shape of a controller instead of the input information by the user U.

It is assumed that the deviation detection unit 255 knows the shape of the controller in advance. The deviation detection unit 255 detects the mounting deviation of the portable display device 200B by comparing the known shape of the controller (an elliptical shape in FIG. 21) with the detection result of the controller output by the image sensor 212. The deviation detection unit 255 outputs the detected mounting deviation to the detection unit 251B.

The deviation detection unit 255 may detect the mounting deviation using a known shape. Therefore, an object having the known shape used by the deviation detection unit 255 is not limited to the controller. For example, the deviation detection unit 255 can detect the mounting deviation similarly to the controller by detecting an object having a known physical shape, such as a package or a cable.

The display control unit 253B corrects the position and the posture of the head of the user U based on the mounting deviation detected by the deviation detection unit 255. The display control unit 253B corrects the position and the posture of the head of the user U after correction.

The detection unit 251B corrects the position and the posture of the hand of the user U based on the mounting deviation detected by the deviation detection unit 255. The detection unit 251B outputs the position and the posture of the hand of the user U after correction to the gesture detection unit 252.

It is noted that the mounting deviation of the portable display device 200B does not significantly affect a display image as compared with the mounting deviation of the head mount device 100. However, the mounting deviation of the portable display device 200B affects naturalness of the operation of the hand by the user U. Therefore, when the deviation detection unit 255 detects the mounting deviation of the portable display device 200B, the user U can more naturally perform an operation using the hand, thereby making it possible to further reduce the burden on the user U.

### 5. Other Embodiments

The above-described embodiments and modifications are examples, and various modifications and applications are possible.

For example, a communication program for executing the above-described operation is stored and distributed in a computer-readable recording medium such as an optical disk, a semiconductor memory, a magnetic tape, or a flexible disk. Then, for example, the program is installed in a computer, and the above-described processing is executed to configure a control device. At this time, the control device may be a device (for example, a personal computer) outside the portable display device 200. Furthermore, the control device may be a device (for example, the control unit 250) inside the portable display device 200.

In addition, the communication program may be stored in a disk device included in a server device on a network such as the Internet so that the communication program can be downloaded to a computer. In addition, the above-described functions may be realized by cooperation of an operating system (OS) and application software. In this case, a portion other than the OS may be stored in a medium and distributed, or the portion other than the OS may be stored in a server device so as to be downloaded to a computer.

Further, among the pieces of processing described in the above embodiments, all or a part of the processing described as being performed automatically can be manually performed, or all or a part of the processing described as being performed manually can be automatically performed by a known method. In addition, the processing procedure, specific name, and information including various data and parameters illustrated in the document and the drawings can be freely and selectively changed unless otherwise specified. For example, the various types of information illustrated in each drawing are not limited to the illustrated information.

In addition, each component of each device illustrated in the drawings is functionally conceptual, and is not necessarily physically configured as illustrated in the drawings. That is, a specific form of distribution and integration of each apparatus is not limited to the illustrated form, and all or a part thereof can be functionally or physically distributed and integrated in any unit depending on various loads, usage conditions, and the like. It is noted that this configuration by distribution and integration may be performed dynamically.

In addition, the above-described embodiments can be appropriately combined in a region in which the processing contents do not conflict with each other.

Furthermore, for example, the present embodiment can be implemented as any configuration constituting a device or a system, for example, a processor serving as a system large scale integration (LSI) or the like, a module using a plurality of processors or the like, a unit using a plurality of modules or the like, a set obtained by further adding other functions to a unit, or the like (that is, a configuration of a part of the device).

It is noted that, in the present embodiment, the system means a set of a plurality of components (devices, modules (parts), and the like), and it does not matter whether all the components are in the same housing. Therefore, a plurality of devices housed in separate housings and connected via a network and one device in which a plurality of modules are housed in one housing are both systems.

Furthermore, for example, the present embodiment can adopt a configuration of cloud computing in which one function is shared and jointly processed by a plurality of devices via a network.

### 6. Conclusion

Although embodiments of the present disclosure have been described above, the technical scope of the present disclosure is not limited to the above-described embodiments as it is, and various modifications can be made without departing from the gist of the present disclosure. In addition, components of different embodiments and modifications may be appropriately combined.

Furthermore, the effects of each embodiment described in the present specification are merely examples and are not limited, and other effects may be obtained.

It is noted that the present technology can also have the following configurations.

(1)

A head mount device comprising:
a housing configured to fix a portable display device thereto; and
a light guidance unit configured to change an angle of view of a sensor mounted on the portable display device so as to allow the sensor to sense at least a lower region below a line-of-sight direction of a user in a mounting state in which the portable display device is fixed to the housing, and the housing is mounted on the user.
   (2)

The head mount device according to (1), wherein the light guidance unit includes a concave mirror configured to expand the angle of view so as to include the lower region.

(3)

The head mount device according to (1) or (2), wherein the light guidance unit guides, to the sensor, incident light incident on an incident port provided in the housing.

(4)

The head mount device according to any one of (1) to (3), wherein the light guidance unit includes a total reflection surface configured to guide incident light at least in a longitudinal direction so as to allow the incident light to be incident on the sensor, wherein the incident light is incident on an incident port provided at a substantially center in the longitudinal direction of a display surface of the portable display device.

(5)

The head mount device according to any one of (1) to (4), wherein the light guidance unit is configured to change an incident direction in the sensor to a direction lower than the line-of-sight direction of the user.

(6)

The head mount device according to any one of (1) to (5), wherein the light guidance unit is configured to guide, to the lower region, light emitted from a light source mounted on the portable display device.

(7)

The head mount device according to any one of (1) to (5), further comprising a second light guidance unit configured to guide, to the lower region, irradiation light emitted from a light source mounted on the portable display device.

(8)

The head mount device according to (7), wherein the light guidance unit and the second light guidance unit are arranged so as to prevent incident light incident on the sensor and the irradiation light from interfering with each other.

(9)

The head mount device according to (7) or (8), wherein the second light guidance unit is configured to guide the irradiation light in a second guidance direction different from a first guidance direction in which the light guidance unit guides incident light to the sensor.

(10)

The head mount device according to any one of (7) to (9), wherein the light guidance unit is disposed offset from the second light guidance unit in the line-of-sight direction.

(11)

The head mount device according to any one of (7) to (10), further comprising a third light guidance unit configured to guide, in the line-of-sight direction, at least one of incident light incident on the light guidance unit and the irradiation light emitted from the second light guidance unit.

(12)

The head mount device according to (11), wherein the third light guidance unit has a refractive index greater than 1.

(13)

The head mount device according to any one of (1) to (12), wherein the portable display device detects an object around the user by correcting a detection signal output from the sensor depending on a change in the angle of view of the sensor by the light guidance unit.

(14)

The head mount device according to any one of (1) to (13), wherein the portable display device detects an object around the user by correcting a detection signal output from the sensor depending on attenuation of incident light incident on the sensor by the light guidance unit.

(15)

A light guidance device configured to change an angle of view of a sensor mounted on a portable display device so as to allow the sensor to sense at least a lower region below a line-of-sight direction of a user in a mounting state in which a head mount device having the portable display device fixed thereto is mounted on the user.

(16)

A portable display device configured to present images to a user by being fixed to a head mount device mounted on the user, the portable display device including:
a sensor configured to detect a surrounding object; and
a controller configured to display, among the images to be presented to the user, a first region and a second region, in which the first region corresponds to a detection range of the sensor and is displayed with a first transmittance, and a second region corresponds to a periphery of the detection range and is displayed with a second transmittance higher than the first transmittance.

### REFERENCE SIGNS LIST

100 HEAD MOUNT DEVICE
110 MAIN BODY PART
120 LID PART
121 OPENING PART
130 LIGHT GUIDANCE UNIT
140 SECOND LIGHT GUIDANCE UNIT
131 INCIDENT PORT
132, 133 CONCAVE MIRROR
134, 135 TOTAL REFLECTION SURFACE
141 EMISSION PORT
160 THIRD LIGHT GUIDANCE UNIT
170 AIR LAYER
200 PORTABLE DISPLAY DEVICE
210 SENSOR UNIT
211 IMAGING DEVICE
212 IMAGE SENSOR
213 LIGHT SOURCE
214 DISTANCE MEASUREMENT DEVICE
220 COMMUNICATION UNIT
230 DISPLAY UNIT
240 STORAGE UNIT
250 CONTROL UNIT
251 DETECTION UNIT
252 GESTURE DETECTION UNIT
253 DISPLAY CONTROL UNIT
254 TRANSMITTANCE DETERMINATION UNIT
255 DEVIATION DETECTION UNIT

1. A head mount device comprising:
a housing configured to fix a portable display device thereto; and
a light guidance unit configured to change an angle of view of a sensor mounted on the portable display device so as to allow the sensor to sense at least a lower region below a line-of-sight direction of a user in a mounting state in which the portable display device is fixed to the housing, and the housing is mounted on the user.

2. The head mount device according to claim 1, wherein the light guidance unit includes a concave mirror configured to expand the angle of view so as to include the lower region.

3. The head mount device according to claim 1, wherein the light guidance unit guides, to the sensor, incident light incident on an incident port provided in the housing.

4. The head mount device according to claim 1, wherein the light guidance unit includes a total reflection surface configured to guide incident light at least in a longitudinal direction so as to allow the incident light to be incident on the sensor, wherein the incident light is incident on an incident port provided at a substantially center in the longitudinal direction of a display surface of the portable display device.

5. The head mount device according to claim 1, wherein the light guidance unit is configured to change an incident direction in the sensor to a direction lower than the line-of-sight direction of the user.

6. The head mount device according to claim 1, wherein the light guidance unit is configured to guide, to the lower region, light emitted from a light source mounted on the portable display device.

7. The head mount device according to claim 1, further comprising a second light guidance unit configured to guide, to the lower region, irradiation light emitted from a light source mounted on the portable display device.

8. The head mount device according to claim 7, wherein the light guidance unit and the second light guidance unit are arranged so as to prevent incident light incident on the sensor and the irradiation light from interfering with each other.

9. The head mount device according to claim 7, wherein the second light guidance unit is configured to guide the irradiation light in a second guidance direction different from a first guidance direction in which the light guidance unit guides incident light to the sensor.

10. The head mount device according to claim 7, wherein the light guidance unit is disposed offset from the second light guidance unit in the line-of-sight direction.

11. The head mount device according to claim 7, further comprising a third light guidance unit configured to guide, in the line-of-sight direction, at least one of incident light incident on the light guidance unit and the irradiation light emitted from the second light guidance unit.

12. The head mount device according to claim 11, wherein the third light guidance unit has a refractive index greater than 1.

13. The head mount device according to claim 1, wherein the portable display device detects an object around the user by correcting a detection signal output from the sensor depending on a change in the angle of view of the sensor by the light guidance unit.

14. The head mount device according to claim 1, wherein the portable display device detects an object around the user by correcting a detection signal output from the sensor depending on attenuation of incident light incident on the sensor by the light guidance unit.

15. A light guidance device configured to change an angle of view of a sensor mounted on a portable display device so as to allow the sensor to sense at least a lower region below a line-of-sight direction of a user in a mounting state in which a head mount device having the portable display device fixed thereto is mounted on the user.
